(19) United States
(12) Patent Application Publication
(10) Pub. No.: US 2026/0300177 A1
(43) Pub. Date: Oct. 1, 2026

(54) DEVICES, SYSTEMS, AND METHODS FOR DIRECT CACHE INJECTION IN NETWORKING DEVICES

(71) Applicants: Advanced Micro Devices, Inc., Santa Clara, CA (US); Xilinx, Inc., San Jose, CA (US)

(72) Inventors: Mahesh UdayKumar Wagh, Austin, TX (US); Anil Kumar, Austin, TX (US); Amit P. Apte, Austin, TX (US); Xuanhua Li, Austin, TX (US); Vydhyanathan Kalyanasundharam, Santa Clara, CA (US); Kevin M. Lepak, Austin, TX (US); Kieran Mansley, Cambridge (GB); Jay Fleischman, Fort Collins, CO (US); Nitish Paliwal, Austin, TX (US)

(73) Assignees: Advanced Micro Devices, Inc., Santa Clara, CA (US); Xilinx, Inc., San Jose, CA (US)

(21) Appl. No.: 19/091,708

(22) Filed: Mar. 26, 2025

(51) Int. Cl. G06F 12/0815

(52) U.S. Cl. CPC G06F 12/0815

(57) ABSTRACT

Devices, systems, and methods for direct cache injection. An example device issues a coherent write request over a cache-coherent memory protocol channel, including a data payload and a device-initiated request packet. The device adds a cache resource identifier in the request packet, providing a steering hint for directing the data payload to a caching resource in the host system. The device sets a locality hint in the request packet, the locality hint indicating one or more access characteristics of the data payload. The data payload is directed to the caching resource based on the cache resource identifier and the temporal locality hint. An example system may further include a device driver that programs the cache resource identifier based on host system topology information and dynamically updates the cache resource identifier based on changes in software scheduling.

### BACKGROUND

In modern computing systems, the efficiency of data processing often depends on the speed and accuracy of data retrieval from memory. The rate at which data is accessed directly influences the execution speed of software applications. Specialized devices have become increasingly important in optimizing data transport schemes. These devices benefit from mechanisms that allow them to place data directly into memory caches, thereby improving overall system performance.

Existing technologies provide processing hints that the system can use to direct transactions to specific resources. However, these solutions often involve data injections for entire payloads, which can exceed the size of a cache line and cause spill-over effects. Protocols that operate on a per-cache-line granularity offer low latency and high performance for data-intensive workloads. Despite these advantages, current channels lack the capability for devices to inject coherent data directly into the CPU's caches. This limitation necessitates a solution that can generalize and address various use cases, enhancing the performance and efficiency of data-intensive applications.

### BRIEF DESCRIPTION OF THE DRAWINGS

FIG. 1 depicts a block diagram of an example system for direct cache injection in networking devices. This example shows a Compute Express Link (CXL)-compliant device interfacing with a host system through a CXL fabric interconnect (CFI).

FIG. 2 illustrates a flow chart diagram of a method for issuing a coherent write request with cache resource identifier and locality hint in using a high-performance interconnect protocol.

FIG. 3 illustrates a block diagram of a device-initiated request packet with a cache resource identifier and a locality hint.

FIG. 4 illustrates a flow chart diagram depicting the process of handling a coherent write request with cache resource identifier and locality hint interpretation.

FIG. 5 illustrates a flow chart diagram depicting the process for programming and using a cache resource identifier (CCXID) for coherent writes in a CXL-compliant device.

FIG. 6 shows a block diagram of a cache hierarchy with eviction tags managed by a QoS controller.

### DETAILED DESCRIPTION

Described herein are various examples of methods, systems, and devices for direct cache injection in networking devices. Coherent interconnect technologies typically provide mechanisms to maintain consistency across multiple caches and memory locations in a host system. Without device-specified cache injection, a host system has limited options when handling writes to a cacheline by an external device. These options may include: (1) invalidating any existing cached copies and writing the data to main memory; (2) invalidating existing cached copies and injecting the updated cacheline into one cache; or (3) overwriting the cacheline contents in all caches currently holding it. In such cases, the behavior is implementation-specific; for example, one manufacturer may adopt the first behavior, while another manufacturer may implement a mechanism that aligns more closely with the second. However, even without device-specified injection, a cacheline may still end up in a cache.

Device-specified cache injection, in accordance with at least some examples described herein, can address (1) ensuring a cacheline is injected into a cache even when no cache currently holds it, and/or (2) allowing the redirection of the cacheline to a different or additional cache when it is already cached. These capabilities can provide more precise control over data placement in cache-coherent memory systems, which may aid in improving performance through placing data closer to the software consumer and relevant compute resources. By steering data payloads to specific caching or compute resources, some disclosed techniques can improve data access efficiency and enable better alignment with the software's execution context.

As will be described in greater detail below, some embodiments of the present disclosure may involve issuing a coherent write request over a high-performance interconnect protocol channel. Such a coherent write request may include a data payload and a device-initiated request packet. The device may add a cache resource identifier (CRI) in the device-initiated request packet, providing a steering hint for directing the data payload to a specific resource in the host system, such as a cache or compute unit. Additionally, the device may set a locality hint in the device-initiated request packet, indicating one or more access characteristics of the data payload. By directing the data payload to the appropriate resource based on the CRI and locality hint, some embodiments can improve data placement and system performance.

Some disclosed systems may include a host system communicatively coupled to a device via a vendor-defined extension protocol. The device may comply with the vendor-defined extension protocol and be configured to issue coherent write requests, add cache resource identifiers, set locality hints, and direct data payloads to specific resources in the host system. A device driver programs the CRI based on host system topology information, ensuring that data payloads are directed to the appropriate resources. Additionally, the device may dynamically update the CRI based on changes in software scheduling, ensuring optimal performance and adaptability to varying conditions.

One example of a vendor-defined extension protocol, provided here by way of illustration and not limitation, is Compute Express Link (CXL). CXL is an open standard interconnect designed to facilitate high-speed communication between central processing units (CPUs) and various types of accelerators, memory, and other peripherals. It aims to provide high bandwidth, low latency, and efficient memory coherency, enhancing the performance and scalability of data centers and high-performance computing environments.

In some examples, a coherent write request may include a type of write operation in a cache-coherent memory system where the data being written is ensured to be consistent across all caches in the system. This ensures that any copies of the data in other caches are updated or invalidated to maintain coherence, enabling all processors in the system to have a consistent view of the memory.

A cache-coherent memory protocol channel may include a communication pathway that ensures data consistency across multiple caches in a computing system. It allows devices to perform read and write operations while maintaining coherence, meaning that any changes to data in one cache are propagated to other caches to ensure that all processors have a consistent view of the memory. This protocol is crucial for systems that require high performance and data integrity, as it minimizes latency and optimizes data retrieval by ensuring that the most recent data is available across the system's caches. To further enhance granularity and control over data placement, the cache-coherent memory protocol may also support steering data to specific cache slices or cache ways within a hierarchical caching structure. A cache resource identifier may include a specific identifier used in a device-initiated request packet to provide a steering hint for directing a data payload to a particular caching resource within a host system. This identifier helps optimize data placement by ensuring that the data is stored in the most appropriate cache, thereby improving data retrieval speed and overall system performance. In some implementations, the cache resource identifier may further encode information specifying a particular cache slice or cache way within the caching hierarchy. This additional granularity enables fine-tuned control over data placement, which is particularly beneficial for systems with distributed or multi-level cache architectures.

A steering hint may include a piece of information provided by a device to guide the host system on where to direct a data payload within the system's memory hierarchy. In some examples, (e.g., in the context of the CXL protocol), it helps in optimizing data placement by indicating the specific caching resource (e.g., a particular cache level, core complex, cache slice, or cache way) where the data should be stored, thereby improving data retrieval speed and overall system performance. By supporting hints that extend to cache slices and cache ways, the system can achieve greater flexibility and efficiency in utilizing the available cache resources, further enhancing performance for data-intensive applications.

A locality hint may include an indicator to specify which entity is more likely to access the data by overloading an existing temporal bit. This hint helps the system make informed decisions about cache placement, such as whether to inject the data directly into the cache or another internal data structure for quick access or to store it in main memory if it is not expected to be used soon. In the context of the CXL protocol, the locality hint is typically represented as a non-temporal (NT) bit, where a value of 0 indicates temporal data (likely to be used soon) and a value of 1 indicates non-temporal data (not likely to be used soon).

Moreover, the term “access characteristics,” as used herein, may include or refer to attributes or properties of a data payload that provide guidance on how the data is likely to be used or accessed within a computing system. These characteristics may include, but are not limited to: (1) frequency of access, which specifies whether the data is expected to be accessed frequently or infrequently; (2) priority level, indicating the importance or criticality of the data relative to other data payloads, which may be used to determine whether the data should reside in faster caching resources; (3) expected access patterns, such as sequential or random access, which may influence the placement of the data in memory or cache slices optimized for those patterns; (4) spatial locality, identifying whether the data is likely to be accessed alongside other data located in contiguous or nearby memory addresses; and (5) temporal relevance, which indicates whether the data is expected to be accessed imminently or at a later time. By encoding one or more of these access characteristics into a locality hint within the device-initiated request packet, the system can dynamically optimize data placement in caching resources or memory hierarchies, thereby improving overall system performance and efficiency. The inclusion of access characteristics ensures that the data placement strategy is tailored to the specific requirements of the software applications or workloads consuming the data.

By issuing a non-cacheable write request over a cache-coherent memory protocol channel, some embodiments of the present disclosure may ensure that data payloads are written in a manner that maintains cache coherence, which is crucial for the integrity and performance of data-intensive applications. In implementations involving a CXL protocol this approach may leverage the CXL protocol to facilitate efficient data transfers between the device and the host system.

Adding a resource identifier in the device-initiated request packet provides a steering hint that directs the data payload to a specific caching resource in the host system. This targeted approach minimizes latency by ensuring that the data is placed in the most appropriate resource, thereby improving the data retrieval speed for subsequent operations. This is particularly beneficial in systems with complex cache hierarchies, as it optimizes the use of available cache resources.

Setting a locality hint in the device-initiated request packet allows the device to indicate whether the data payload is likely to be used in the near future. This enables the host system to make informed decisions about cache placement, such as whether to inject the data directly into the cache or to store it in main memory. This dynamic handling of data based on its temporal locality enhances the overall efficiency of the caching mechanism.

Directing the data payload to the resource of the host system based on the resource identifier and the locality hint ensures that the data is optimally placed for quick access by software applications. This approach not only reduces the need for expensive snoops and probes across the coherent fabric, thereby lowering power consumption and improving system performance, but also eliminates the significant latency associated with DRAM reads when the cacheline is written directly to memory instead of being placed in a cache. By ensuring that critical data is available in the appropriate cache or resource, the system avoids unnecessary memory accesses, further enhancing performance and responsiveness, particularly for data-intensive workloads.

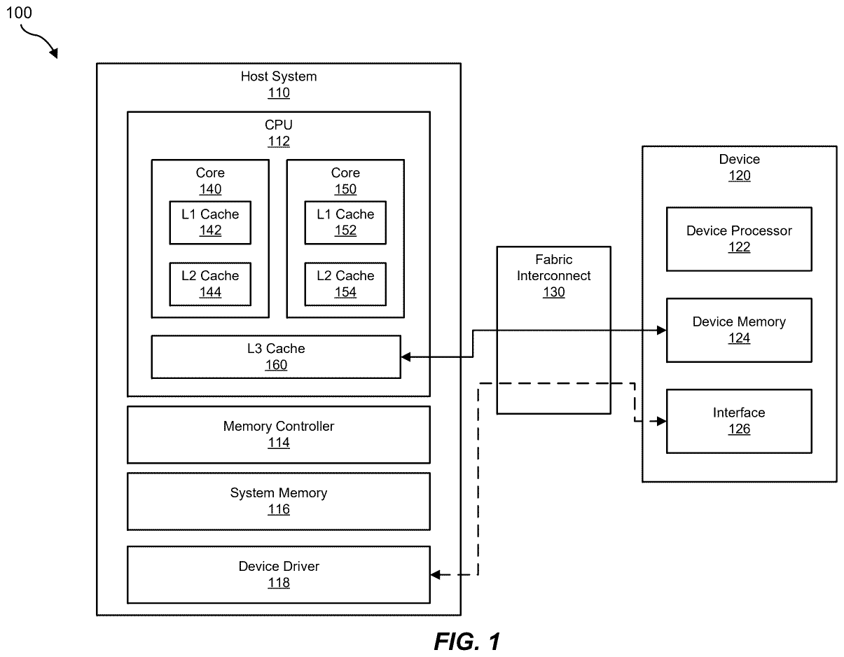

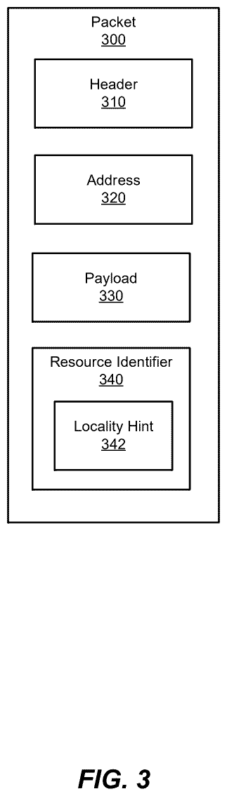

The following will describe, in relation to FIG. 1 and FIGS. 3 through 6 various example systems, devices, and implementations of a direct cache injection mechanism. Various methods of direct cache injection will also be described in relation to FIG. 3.

FIG. 1 shows an example system 100 that implements a CXL-compliant device interfacing with a host system through a CFI. Example system 100 illustrates the architecture and components involved in enabling high-speed, low-latency communication between a device and a host system using the CXL protocol. This example highlights how the CXL protocol facilitates coherent memory access and device-to-host communication. However, it is important to note that the techniques and systems described herein are not limited to the CXL protocol. Principles described herein may be applied to any suitable interconnect technology that supports coherent memory access, data steering, and device-initiated cache injection.

For instance, the described methods and systems could be implemented using PCI Express (PCIe) with extensions for memory coherence, AMD's Infinity Fabric, or any proprietary interconnects supporting similar functionalities. These interconnects may employ different protocols for achieving coherence and communication between devices and hosts but can still leverage the CRI and locality hints as described herein to optimize data placement within caching resources. The system's flexibility allows it to adapt to diverse interconnect technologies, ensuring broader applicability across different architectures and use cases.

The architecture in FIG. 1 includes components such as a host system, a device (e.g., an accelerator or network interface controller), and the interconnect fabric. While the example shows a CXL-compliant device, the methods described herein can be generalized for devices operating over any coherent memory protocol channel. This adaptability ensures the proposed invention remains relevant as interconnect technologies evolve, further highlighting the system's robustness and versatility.

As shown in FIG. 1, example system 100 includes a host system 110 and a device 120 communicatively coupled via a CFI 130. In general, host system 110 is responsible for executing software applications, managing data flow, and interfacing with external devices through protocols such as CXL. In general, device 120 is an external device that interfaces with the host system via the CXL protocol. It includes a device processor, device memory, and a CXL interface, enabling it to issue coherent write requests, add cache resource identifiers, and set locality hints to optimize data placement in the host system's caches. It should be appreciated that while in the example of FIG. 1 and in other examples described below, a hardware component that performs operations described herein is a processor, embodiments are not so limited. Embodiments may operate with any suitable circuit(s) that implement techniques described herein. Such circuits may include Application Specific Integrated Circuits (ASICs), programmable logic devices (PLDs) including Field Programmable Gate Arrays (FPGAs) and other programmable logic, circuits that execute instructions (including software, firmware, or other instructions) such as processors, and other circuits. Embodiments that operate with a processor may operate with any suitable form of processor, including a single- or multi-core central processing unit (CPU), graphics processing unit (GPU), accelerated processing unit (APU), neural processing unit (NPU), and/or other processor, and in any suitable packaging including a microprocessor, microcontroller, system on a chip (SoC), or other packaging. Embodiments are not limited to operating with a particular form of circuit.

Host system 110 is a primary computing system that includes several key components responsible for executing software applications, managing data flow, and interfacing with external devices. As shown, host system 110 includes Central Processing Unit (CPU) 112, memory controller 114, system memory 116 and device driver 118.

The CPU 112 is the main processing unit of host system 110 and may be responsible for executing instructions and processing data. It typically includes multiple cores and cache levels to enhance parallel processing and data retrieval efficiency. As shown, CPU 112 includes processing cores 140 and 150. These are individual cores within CPU 112 that perform parallel processing tasks. Each processing unit can execute instructions independently, allowing for efficient multitasking and improved performance. Note that, while only two cores are illustrated herein, CPU 112 may include any suitable number of cores.

CPU 112 also includes L1 caches 142 and 152, L2 caches 144 and 154, and L3 caches 160. The L1 caches are the first level of caching for the processing cores 140 and 150, respectively. They store frequently accessed data and instructions, providing low-latency access to the processing units and improving overall performance.

The L2 caches serve as the second level of caching for the processing cores 140 and 150, respectively. They store a larger amount of data and instructions compared to the L1 caches, further reducing latency and improving data retrieval efficiency.

The L3 caches may be used as shared cache resources, but modern CPUs may divide the L3 cache into separate slices shared by smaller groups of cores, often referred to as core complexes. These split L3 caches provide high-capacity storage for frequently accessed data and instructions, but their segmented structure introduces new challenges for ensuring efficient data placement. Device-specified cache injection plays a critical role in directing writes to the appropriate L3 cache slice or resource, ensuring that data is optimally located for access by the intended core complex. Without such targeted injection, writes could be placed in an L3 cache slice that is inaccessible to the cores that need the data, leading to inefficiencies and increased latency. Incorporating slice-level addressability further enhances control and granularity, aligning data placement with the needs of specific processing units.

Memory controller 114 manages the flow of data between the CPU 112 and the system memory 116. It is responsible for coordinating memory access requests, ensuring data consistency, and optimizing memory bandwidth utilization. The memory controller plays a crucial role in maintaining efficient communication between the CPU and the system memory.

The system memory 116, typically implemented as dynamic random-access memory (DRAM), stores data and instructions for the CPU 112. It provides a larger storage capacity compared to the CPU caches, allowing for the storage of a vast amount of data required by software applications. The system memory is accessed by the CPU through the memory controller 114.

The device driver 118 is software running on the host system that manages the communication and coordination between the host system and external devices, such as the device 120. The device driver is responsible for programming the CCXID based on the host system's System on Chip (SOC) topology information. It ensures that data payloads are directed to the appropriate caching resources within the host system, optimizing data placement and improving overall system performance. The device driver also dynamically updates the CCXID based on changes in software scheduling to maintain optimal performance.

These elements work together to ensure efficient data processing, memory management, and communication with external devices, enhancing the overall performance and responsiveness of the host system 110.

The device 120 is an external device (i.e., external to host system 110) that interfaces with the host system via the CXL protocol. It is designed to enhance data processing and communication efficiency by leveraging the CXL protocol's capabilities. The elements included in the device 120 are device processor 122, device memory 124, and CXL interface 126.

The device processor 122 is a functional component within the device, responsible for executing instructions, processing data, and managing the overall operation of the device. The term “processor” as used herein refers to a generalized processing entity, which may be implemented as either a programmable processor (such as a CPU or microcontroller) capable of executing a series of instructions or as fixed logic circuitry designed to perform specific tasks. This component handles key operations such as generating and issuing coherent write requests, adding cache resource identifiers, and setting locality hints. Whether implemented as programmable logic or fixed hardware, the device processor plays a crucial role in optimizing data placement and communication with the host system, ensuring efficient and precise interactions within a cache-coherent memory protocol.

The device memory 124, if present, is local memory within the device, used for temporary storage and processing of data. It stores data and instructions required by the device processor 122, enabling efficient data processing and reducing latency. The device memory can be implemented using any suitable type or collection of memory technologies, such as DRAM and/or SRAM, depending on the performance and capacity requirements of the device. In some implementations, the device may not include dedicated memory and may instead rely on caching host memory to optimize data access and processing. Alternatively, the device may write directly to host memory without the use of device memory or caching, as determined by the specific requirements and design of the system. This flexibility allows the device to adapt to various configurations, ensuring compatibility and performance across different use cases.

The interface 126 is a communication interface that enables the device to connect and communicate with the host system via a cache-coherent memory protocol. This interface facilitates high-speed data transfer and ensures that coherent write requests, cache resource identifiers, and locality hints are transmitted efficiently between the device and the host system. The interface supports multiple protocol features designed to handle operations such as I/O, cache-coherent memory access, and memory expansion.

For example, the interface may leverage CXL, which includes sub-protocols such as CXL.io for I/O operations, CXL.cache for cache-coherent memory access, and CXL.memory for memory expansion. However, the methods and systems described herein are not limited to CXL and can be applied to other cache-coherent memory protocols or proprietary interconnects offering similar functionalities. One or more components in device 120 may include or function as one or more mechanisms or modules. For example, device 120 may include or implement a coherent write request mechanism. A coherent write mechanism may include or represent a functional component within the CXL-compliant device that generates and issues coherent write requests to the host system. It may ensure that data payloads are written in a manner that maintains cache coherence, which is crucial for the integrity and performance of data-intensive applications. This mechanism may leverage the CXL protocol to facilitate efficient data transfers between the device and the host system.

Device 120 may also include or implement a CCXID mechanism. The CCXID mechanism may be responsible for adding a CCXID in the device-initiated request packet. The CCXID provides a steering hint for directing the data payload to a specific caching resource in the host system. This targeted approach minimizes latency by ensuring that the data is placed in the most appropriate cache, thereby improving data retrieval speed for subsequent operations.

Device 120 may also include or implement a locality hint mechanism. The locality hint mechanism may set a locality hint in the device-initiated request packet. The locality hint indicates whether the data payload is likely to be used in the near future. This enables the host system to make informed decisions about cache placement, such as whether to inject the data directly into the cache or to store it in main memory. This dynamic handling of data based on its temporal locality enhances the overall efficiency of the caching mechanism.

These elements work together to ensure efficient data processing, memory management, and communication with the host system, enhancing the overall performance and responsiveness of the device 120. By leveraging the capabilities of the CXL protocol, the CXL-compliant device can optimize data placement, reduce latency, and improve the performance of data-intensive applications.

The CFI 130 may facilitate high-speed, low-latency communication between the host system 110 and the device 120. It may leverage the CXL protocol to ensure efficient data transfer and coherence across the system. The CFI 130 includes several key elements and functionalities.

A physical layer of the CFI 130 is responsible for the actual transmission of electrical signals between the host system and the CXL-compliant device. It typically uses the PCI Express (PCIe) infrastructure as the underlying physical layer, providing a robust and widely adopted foundation for high-speed data transfer. The physical layer ensures reliable signal integrity and data transmission over the interconnect.

A data link layer of the CFI 130 manages the reliable transfer of data packets between the host system and the CXL-compliant device. It includes mechanisms for error detection and correction, flow control, and data packet framing. The data link layer ensures that data packets are transmitted accurately and efficiently, maintaining the integrity of the data being transferred.

A transaction layer of the CFI 130 is responsible for managing the high-level communication protocols and transactions between the host system and the CXL-compliant device. It handles the generation, transmission, and reception of transaction layer packets (TLPs), which encapsulate the data and control information for various operations. The transaction layer supports multiple CXL sub-protocols, including CXL.io, CXL.cache, and CXL.memory, enabling a wide range of communication and data transfer scenarios.

The CXL.io protocol is a sub-protocol of the CXL standard that handles standard I/O operations. It is similar to traditional PCIe transactions and is responsible for tasks such as device enumeration, configuration, and data transfer. The CXL.io protocol ensures seamless integration and communication between the host system and the CXL-compliant device for I/O operations.

The CXL.cache protocol is a sub-protocol of the CXL standard that enables cache-coherent memory access between the host system and the CXL-compliant device. It allows the device to read and write to the host's memory while maintaining cache coherence, ensuring that all participants in the system have a consistent view of the memory. The CXL.cache protocol operates on a per-cache-line granularity, providing low-latency access to memory and improving the performance of data-intensive workloads.

The CXL.memory protocol is a sub-protocol of the CXL standard that provides a mechanism for memory expansion. It allows the CXL-compliant device to access additional memory resources that are not directly attached to the host processor. The CXL.memory protocol enables memory pooling and sharing across multiple devices, improving memory utilization and system scalability.

The CFI 130 facilitates the handling of coherent write requests from the CXL-compliant device to the host system. It ensures that data payloads are written in a manner that maintains cache coherence, which is crucial for the integrity and performance of data-intensive applications. The CFI 130 manages the transmission of device-initiated request packets, including the cache resource identifier and locality hint, to the host system.

Additionally, the CFI 130 ensures the efficient transmission of the cache resource identifier CCXID from the CXL-compliant device to the host system. The CCXID provides a steering hint for directing the data payload to a specific caching resource in the host system. This targeted approach minimizes latency by ensuring that the data is placed in the most appropriate cache, thereby improving data retrieval speed for subsequent operations.

Moreover, the CFI 130 facilitates the transmission of the locality hint from the CXL-compliant device to the host system. The locality hint may indicate whether the data payload is likely to be used in the near future, enabling the host system to make informed decisions about cache placement. This dynamic handling of data based on its temporal locality enhances the overall efficiency of the caching mechanism.

These elements and functionalities of the CFI 130 work together to ensure efficient data transfer, cache coherence, and optimized data placement between the host system and the CXL-compliant device. By leveraging the capabilities of the CXL protocol, the CFI 130 enhances the performance and responsiveness of data-intensive applications, providing a robust foundation for high-speed, low-latency communication in modern computing systems.

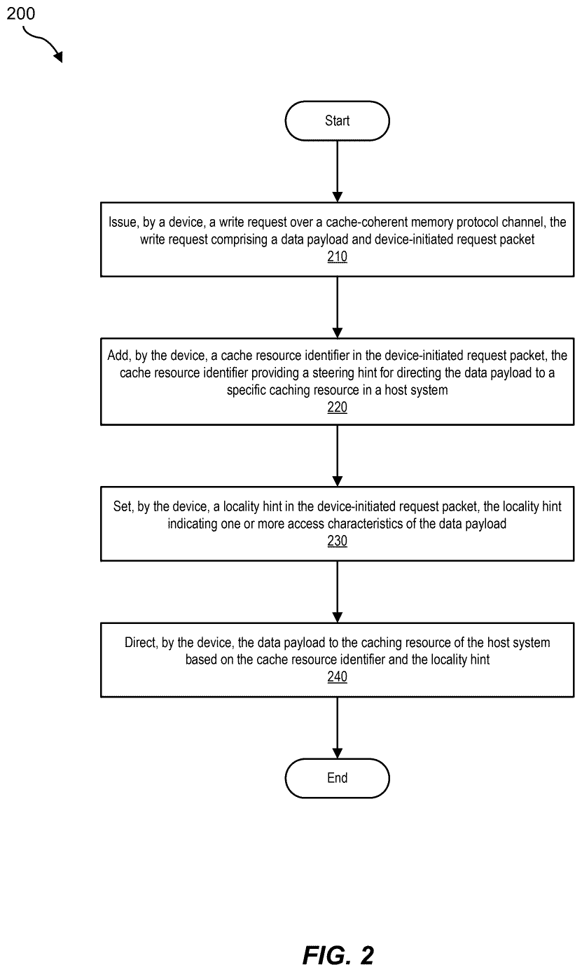

FIG. 2 shows a flow diagram of an example method 200 for issuing a coherent write request with a cache resource identifier and a locality hint in a CXL protocol. Example method 200 may be implemented by one or more components of one or more of the example systems described herein (e.g., example system 100). As shown, process 210 involves issuing a coherent write request over a cache-coherent memory protocol channel. The coherent write request comprises a data payload and a device-initiated request packet.

In at least one embodiment, the device-initiated request packet may be a Device-to-Host (D2H) request packet. A Device-to-Host (D2H) request packet is a type of communication packet used in various interconnect protocols, including CXL, to facilitate data transfer and control information exchange from a peripheral device to a host system. A D2H request packet may be initiated by device 120 and sent to host system 110 to request specific actions or to transfer data.

The operations of process 210 may be accomplished in any suitable way. For example, in the context of the elements described in reference to FIG. 1, this process begins with device 120. The device processor 122 generates the coherent write request, which comprises a data payload and a device-initiated request packet. The data payload represents the actual data that needs to be written to the host system's memory, while the device-initiated request packet contains control information necessary for the host system to process the request.

Process 220 involves adding, by the device, a cache resource identifier in the device-initiated request packet. The cache resource identifier provides a steering hint for directing the data payload to a caching resource in a host system. In one embodiment, the cache resource identifier is a 4-bit identifier, allowing for up to 16 unique caching resources to be specified. In some examples, the cache resource identifier can be used to direct the data payload to a specific core complex in the host system, optimizing data placement and retrieval.

Likewise, process 230 involves setting, by the device, a locality hint in the device-initiated request packet. The locality hint indicates the temporal locality of the data payload. In one embodiment, the locality hint is a non-temporal (NT) bit, where a value of 0 indicates temporal data and a value of 1 indicates non-temporal data.

By way of illustration, FIG. 3 shows a block diagram of a device-initiated request packet 300 with a cache resource identifier and a locality hint. The packet 300 includes several components that facilitate the transmission of coherent write requests from a device to a host system. The packet 300 begins with a header 310, which contains control information necessary for the host system to process the request. The header 310 may include fields such as packet type, length, and other metadata that define the structure and purpose of the packet.

Following the header 310, the packet 300 includes an address 320. The address 320 specifies the memory location in the host system (e.g., host system 110) where the data payload is written. This address is typically cache-line aligned, ensuring that the data is placed in the correct memory location for efficient access and retrieval.

The packet 300 also includes a payload 330, which represents the actual data that needs to be written to the host system's memory. The payload 330 contains the data that the device is transmitting to the host system, and the payload 330 is necessary for maintaining the integrity and performance of data-intensive applications.

Additionally, the packet 300 includes a cache resource identifier 340. The cache resource identifier 340 provides a steering hint for directing the data payload to a specific caching resource in the host system. This targeted approach minimizes latency by ensuring that the data is placed in the most appropriate cache, thereby improving data retrieval speed for subsequent operations.

The packet 300 further includes a locality hint 342. The locality hint 342 indicates whether the data payload is likely to be used in the near future. This enables the host system to make informed decisions about cache placement, such as whether to inject the data directly into the cache or to store the data payload in main memory. This dynamic handling of data based on the locality hint 342 enhances the overall efficiency of the caching mechanism.

The generation of the CCXID values and the temporal locality hint involves several steps and components within host system 110 and device 120. The device driver 118 running on host system 110 may obtain host SOC topology information from the system BIOS through ACPI tables. This information may include details about the caching resources available in the host system, such as the number and types of caches (e.g., L1, L2, L3) and their respective identifiers. While the use of BIOS and ACPI tables is one example of obtaining CCXID values, other mechanisms may also be employed, such as proprietary interfaces, runtime queries, or preconfigured mappings within the host system.

CCXID values specify potential caching or resource destinations within the host system. Each CCXID value corresponds to a unique destination, such as a specific core complex, cache level, or cache slice, allowing precise control over data placement. The mapping of CCXID values to destinations may be managed by the device, which determines the appropriate CCXID value to use based on contextual factors, such as the memory address being written. This mapping enables the device to dynamically associate a write transaction with the most suitable destination resource.

For example, the device may analyze the memory address being written and apply predefined rules or lookup tables to select the corresponding CCXID value. These rules may be based on host SOC topology information, which includes the association of memory regions with specific caches or compute resources. By leveraging this mapping, the device ensures that data payloads are directed to the optimal destination, aligning with the intended access patterns and minimizing latency.

In addition to analyzing the memory address being written, other approaches may also be used to determine an appropriate CCXID. For instance, the device may associate a “flow” with a destination cache, where the flow is identified based on the contents of the data being written, such as those associated with a specific network connection. In this scenario, the device could reference a lookup table, programmed by the host or device driver, to map specific flows to corresponding CCXID values. This approach may leverage characteristics of the data itself, rather than its write destination address, to optimize cache placement. Such flexibility may ensure that the system can accommodate a variety of data patterns and use cases, further enhancing performance and adaptability.

Based on the obtained SOC topology information, the device driver 118 programs the cache resource identifier (CCXID) in device 120. The programming involves writing the appropriate CCXID values into the device's registers or memory locations, which are used to generate the cache resource identifier for each coherent write request. When the device processor 122 generates a coherent write request, it includes the programmed CCXID in the device-initiated request packet (e.g., as cache resource identifier 340). The CCXID provides a steering hint that directs the data payload to the specific caching resource in the host system, optimizing data placement and reducing latency.

The locality hint (e.g., locality hint 342) is generated to indicate one or more access characteristics of the data payload, such as whether the data payload is likely to be used in the near future. The device processor 122 determines the locality of the data payload based on the nature of the data and the expected usage patterns of the software application. For example, if the data is expected to be accessed frequently and soon after it is written, it is considered temporal. If the data is not expected to be accessed in the near future, it is considered non-temporal. Based on the determined temporal locality, the device processor 122 sets the appropriate value for the locality hint in the device-initiated request packet. The locality hint is typically represented as a single bit (e.g., NT bit), where a value of 0 indicates temporal data, and a value of 1 indicates non-temporal data. When the device processor 122 generates the coherent write request, it includes the locality hint in the device-initiated request packet. This hint helps the host system make informed decisions about cache placement, such as whether to inject the data directly into the cache or to store it in main memory.

The device driver 118 may dynamically update the CCXID programming based on changes in software scheduling or other factors. This ensures that the cache resource identifier (e.g., cache resource identifier 340) remains optimized for the current execution context, maintaining optimal performance and adaptability to varying system conditions. By generating the cache resource identifier 340 and locality hint 342, the device 120 and the host system 110 work together to optimize data placement, reduce latency, and improve the overall efficiency of data-intensive applications.

Returning to FIG. 2, process 240 involves directing the data payload to the caching resource of the host system based on the cache resource identifier and the locality hint.

The CXL interface 126 facilitates the transmission of the coherent write request from the device 120 to the host system 110 via the CFI 130. The CFI 130 ensures high-speed, low-latency communication between the device 120 and the host system 110, leveraging the CXL protocol to maintain cache coherence and efficient data transfer. The physical layer of the CFI 130 handles the actual transmission of electrical signals, while the data link layer manages error detection, correction, and flow control. The transaction layer of the CFI 130 encapsulates the data and control information into transaction layer packets (TLPs) for transmission.

Upon receiving the coherent write request, the host system 110, which includes a CPU 112, memory controller 114, system memory 116, and device driver 118, processes the request. The CPU 112, with multiple processing cores 140 and 150, and associated cache levels (L1 caches 142 and 152, L2 caches 144 and 154, and L3 cache 160), plays a role in executing instructions and managing data flow. The memory controller 114 coordinates memory access requests, ensuring data consistency and optimizing memory bandwidth utilization. The device driver 118, running on the host system, manages the communication and coordination between the host system and the device 120, ensuring that the data payload is directed to the appropriate caching resources within the host system.

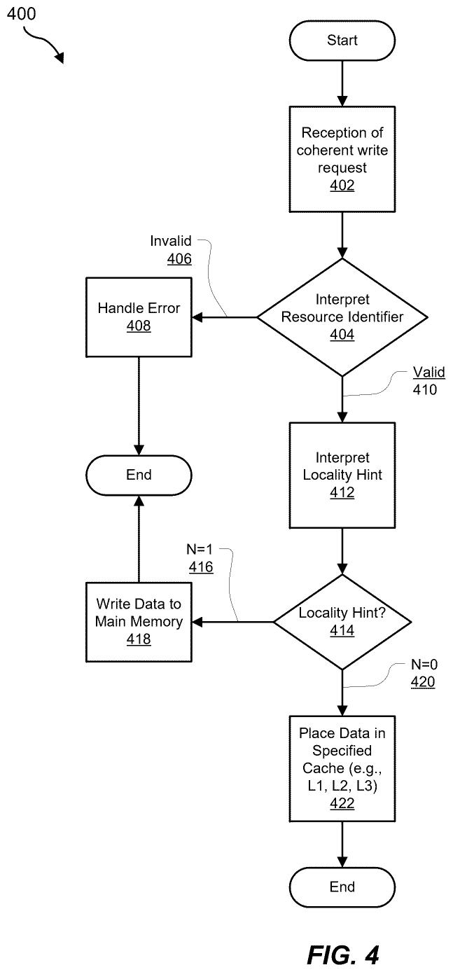

FIG. 4 shows a flow chart diagram depicting an operational flow 400 of handling a coherent write request with cache resource identifier and locality hint interpretation.

The process begins with the reception by host system 110 of a coherent write request (process 402). This step involves receiving a coherent write request from device 120 via CFI 130. As mentioned above, the coherent write request includes a data payload and a device-initiated request packet.

Next, the host system 110 interprets the cache resource identifier (decision 404). This step involves the CPU 112 extracting and interpreting the cache resource identifier from the device-initiated request packet. The cache resource identifier provides a steering hint for directing the data payload to a specific caching resource in the host system, such as the L1 cache 142, L2 cache 144, or L3 cache 160.

The process then checks the validity of the cache resource identifier. If the cache resource identifier is invalid (path 406), the host system 110 handles the error (process 408). This step involves executing error-handling procedures to address the invalid cache resource identifier, and the process ends.

If the cache resource identifier is valid (path 410), the host system 110 proceeds to interpret the locality hint (process 412). This step involves the CPU 112 extracting and interpreting the locality hint from the device-initiated request packet. The locality hint indicates whether the data payload is likely to be used in the near future.

The process then checks the locality hint (process 414). If the locality hint indicates that the data is non-temporal (N=1) (path 416), the memory controller 114 writes the data to the system memory 116 (process 418). This step involves storing the data payload directly in the main memory, as the data is not expected to be accessed in the near future. It should be noted that the locality hint (NT bit) is a hint, and the CPU is free to ignore it and write non-temporal (NT=1) data into a cache or temporal (NT=0) data into system memory based on its internal policies or constraints.

If the locality hint indicates that the data is temporal (N=0) (path 420), the CPU 112 places the data in a cache associated with the core complex likely to process the data, as indicated by the cache resource identifier (CCXID) (process 422). This step involves using the CCXID to direct the data payload to the most appropriate caching resource tied to the targeted core, ensuring quick access by the relevant software applications. While the CCXID could theoretically distinguish between cache levels (e.g., L1, L2, or L3), its primary purpose is to identify the core complex and steer data placement into caches associated with that core. This ensures that the data is optimally positioned for processing, reducing access latency and improving overall system efficiency.

The process concludes after the data is either written to the main memory or placed in the specified cache level, enhancing the overall efficiency and performance of the system.

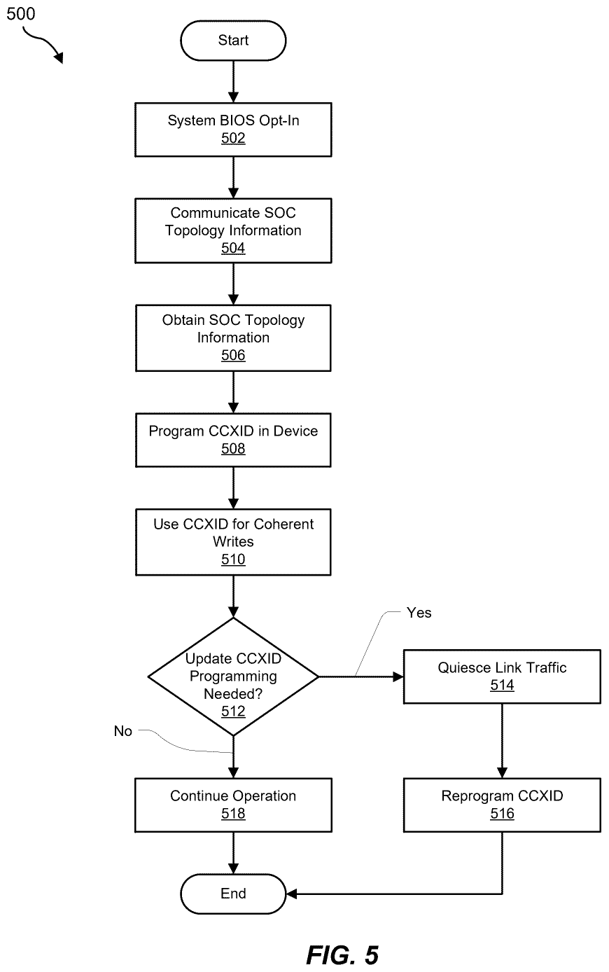

FIG. 5 illustrates a flow chart diagram (flow 500) depicting the process for programming and using CCXID for coherent writes in a CXL device, involving operations performed by host system 110, device 120, and/or CFI 130.

The process begins with the System BIOS of the host system 110 opting in (process 502). This step involves the System BIOS enabling support for CXL.Cache payload steering capabilities and programming the host SOC fabric to support the feature requirements.

Next, the System BIOS communicates the SOC topology information (process 504). This step involves the System BIOS providing the host SOC topology information to the operating system (OS) through ACPI tables.

The device driver 118 of the host system 110 then obtains the SOC topology information (process 506). The CXL device driver, registered with the OS, retrieves the host SOC topology information that includes resource IDs such as CCXIDs.

Following this, the device driver 118 programs the CCXID in the device 120 (process 508). The device driver programs the CCXID information in the device and provides guidance on how to use them. For example, the device driver may associate CCXIDs to address bits in the outbound request.

The device 120 then uses the CCXID for coherent writes (process 510). The CXL-compliant device utilizes the programmed CCXID bits for coherent writes to the host system 110, directing the data payload to specific caching resources based on the CCXID information via the CFI 130.

The process then checks if an update to the CCXID programming is needed (decision 512). This decision point determines whether the CCXID programming needs to be updated based on changes in software scheduling or other factors.

If an update is needed, the process may optionally proceed to quiesce the link traffic (process 514). This step involves pausing the link traffic between the device 120 and the host system 110 via the CFI 130 to ensure that the update can be performed without disrupting ongoing operations. However, quiescence is not strictly required, as the CCXID values table can be updated in a live system. In such cases, the host memory and caching system will handle any temporary mismatches, ensuring data integrity and correct operation even if there is a brief window where data is directed to an incorrect cache.

Whether or not quiescence is performed, the device driver 118 reprograms the CCXID (process 516). The device driver updates the CCXID programming in the device 120 to reflect the new software scheduling or other changes, ensuring optimal performance. In live update scenarios, the host system's memory and cache coherence mechanisms may incur a minor overhead during the transition but will maintain consistent values for the cores.

Once the CCXID is reprogrammed, the process continues operation (process 518). The device 120 resumes operation with the updated CCXID programming, ensuring that coherent writes are directed to the appropriate caching resources in the host system 110. For live updates, this transition occurs seamlessly, minimizing disruption to ongoing operations.

If no update is needed, the process directly continues operation (process 518) without quiescing the link traffic or reprogramming the CCXID. The process concludes with the end of the flow (End).

In addition to monitoring and managing cache usage, the present disclosure leverages advanced techniques to optimize data placement within the cache hierarchy. By utilizing the cache resource identifier (CCXID) and locality hint, the system can make informed decisions about where to store data, further enhancing performance and efficiency.

While the CCXID mechanism plays a crucial role in optimizing data placement, it is equally important to manage cache resources effectively to ensure fair usage and maintain overall system performance. Quality of Service (QoS) is a set of technologies and mechanisms used to manage network resources and ensure the efficient and reliable delivery of data. QoS aims to prioritize certain types of traffic, control bandwidth allocation, and reduce latency and packet loss, thereby enhancing the overall performance and user experience. In computing systems, QoS is particularly important for applications that require consistent and predictable performance, such as real-time communications, video streaming, and data-intensive workloads.

Quality of Service (QoS) mechanisms typically involve traffic classification, traffic shaping, and resource reservation. Traffic classification identifies and categorizes different types of traffic based on predefined criteria, such as application type, source, and destination. Traffic shaping regulates the flow of data to ensure that high-priority traffic receives the necessary resources, while lower-priority traffic is managed to prevent congestion. Resource reservation allocates specific amounts of bandwidth and other resources to ensure that critical applications receive the required level of service.

In the context of the present disclosure, QoS features are implemented to manage cache resources and ensure fair usage among multiple devices and applications. The present disclosure extends known QoS and eviction policies for cache management by introducing device-provided hints that enhance decision-making without dictating specific implementation details. These hints are intended to augment the host system's ability to manage cache resources dynamically and adaptively.

The QoS mechanism in of the present disclosure places eviction tags on cache lines to indicate eviction priority. These tags help manage which cache lines should be evicted when there is a conflict or when the cache is full. By assigning eviction priority, the QoS mechanism ensures that high-priority data remains in the cache, while lower-priority data is evicted to make room for new data. However, the eviction policies themselves remain the purview of the host system's implementation and may vary depending on system design.

The QoS mechanism also monitors cache usage to prevent any single device from dominating the cache resources. This monitoring involves tracking the usage of cache lines by different devices and applications, ensuring that each device receives a fair share of the cache resources. If the QoS mechanism detects that a device is using an excessive amount of cache resources, it can adjust the eviction priority to balance the cache usage and maintain overall system performance.

Additionally, the QoS mechanism in the present disclosure leverages the cache resource identifier (CCXID) and locality hint to optimize data placement in the cache hierarchy. The CCXID provides a steering hint for directing the data payload to a specific caching resource, while the locality hint indicates whether the data is likely to be used in the near future. Importantly, these hints serve as advisory inputs rather than prescriptive directives, allowing the resource managing the cache to implement its own eviction and placement policies while benefiting from the additional information provided by the device.

Overall, the QoS features of the present disclosure enhance the efficiency and performance of the system by managing cache resources, prioritizing critical data, and ensuring fair usage among multiple devices and applications. These mechanisms contribute to a more responsive and reliable computing environment, particularly for data-intensive workloads and real-time applications. By integrating device-provided hints, the system achieves improved adaptability without constraining the host's flexibility in managing its resources.

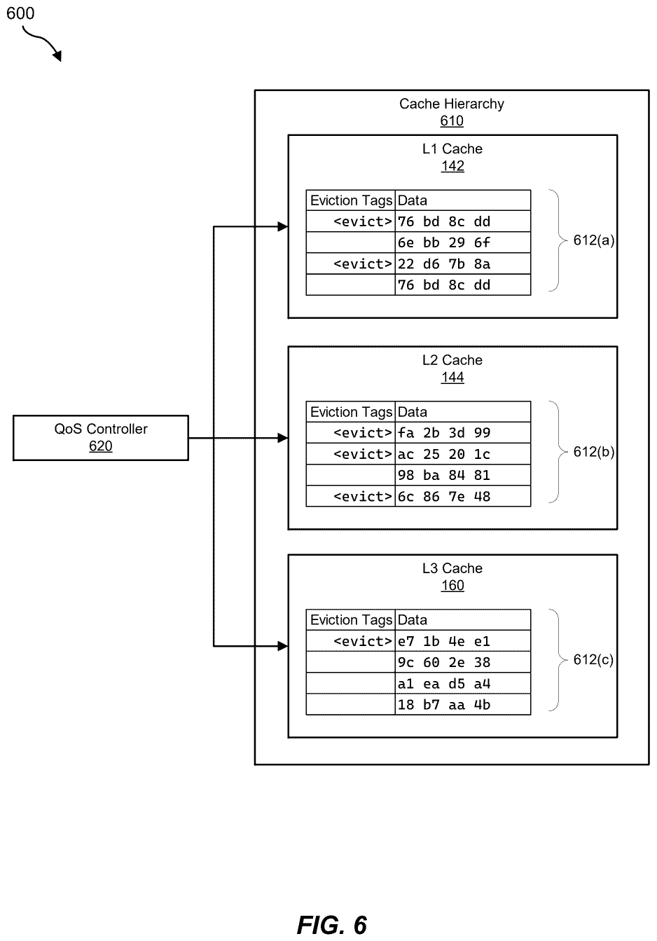

FIG. 6 shows a block diagram of an example system 600 that illustrates a cache hierarchy with eviction tags managed by a QoS controller.

The example system 600 includes a cache hierarchy 610, which comprises multiple levels of cache, specifically L1 cache 142, L2 cache 144, and L3 cache 160. Each cache level contains cache lines 612(a), 612(b), and 612(c) respectively, which store data and associated eviction tags. In some examples, system 600 may be implemented as part of example system 100.

The L1 cache 142 Is the first level of caching in the hierarchy. The L1 cache 142 includes eviction tags and data for each cache line 612(a). The eviction tags are used to manage the priority of cache lines for eviction when the cache is full or when new data needs to be stored. The data associated with each eviction tag represents the actual information stored in the cache line.

The L2 cache 144 is the second level of caching in the hierarchy. Similar to the L1 cache 142, the L2 cache 144 includes eviction tags and data for each cache line 612(b). The eviction tags in the L2 cache 144 help manage the eviction priority of cache lines, ensuring that high-priority data remains in the cache while lower-priority data is evicted to make room for new data.

The L3 cache 160 is the third level of caching in the hierarchy. The L3 cache 160 also includes eviction tags and data for each cache line 612(c). The eviction tags in the L3 cache 160 play a role in managing the eviction priority of cache lines, optimizing the use of cache resources and improving overall system performance.

The QoS controller 620 is responsible for managing the eviction tags across the entire cache hierarchy 610. The QoS controller 620 monitors cache usage and ensures fair allocation of cache resources among multiple devices and applications. The QoS controller 620 places eviction tags on cache lines to indicate their eviction priority, helping to manage which cache lines are to be evicted when there is a conflict or when the cache is full.

The QoS controller 620 also tracks the usage of cache lines by different devices and applications, ensuring that each device receives a fair share of the cache resources. If the QoS controller 620 detects that a device is using an excessive amount of cache resources, the QoS controller 620 can adjust the eviction priority to balance the cache usage and maintain overall system performance.

By leveraging the cache resource identifier (CCXID) and locality hint, the QoS controller 620 can make informed decisions about cache placement, ensuring that high-priority and frequently accessed data is stored in the most appropriate cache level. This dynamic handling of data based on the temporal locality enhances the overall efficiency of the caching mechanism.

In summary, the present disclosure relates to a method for improving the performance of computing systems by enabling direct cache injection from CXL-compliant devices. One element is to allow these devices to place data directly into the host system's caches, thereby increasing the data cache hit rate and reducing latency. This is achieved by adding cache resource identifier (CCXID) bits in the Device-to-Host (D2H) Request channel and using the existing Non-Temporal (NT) bit to provide locality hints on a per-cache-line basis.

One problem addressed by embodiments of the present disclosure is that current CXL.Cache protocols lack the ability for devices to inject coherent data directly into CPU caches, which can lead to inefficiencies. Existing solutions use TLP processing hints but are not optimized for CXL.Cache's low-latency, per-cache-line operations.

The present disclosure therefore proposes two features: (i) adding CCXID information in D2H Requests to steer the data payload, and (ii) reusing the NT bit to provide locality hints to the host fabric. A device driver programs the CCXIDs based on Host SOC topology information, communicated via ACPI tables and programmed over the CXL.IO channel.

The advantages of this solution include increased data cache hit rates and reduced latency, as well as reduced snoops/probes, which lower power consumption and coherent fabric activity. This method ensures that data payloads are directed to the appropriate caching resources, optimizing data placement and improving overall system performance. Embodiments of the present disclosure may be particularly beneficial for data-intensive applications, as they may enhance the efficiency and responsiveness of the computing environment.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is

1. A method comprising:
issuing, by a device, a write request over a cache-coherent memory protocol channel, the write request comprising a data payload and device-initiated request packet;
adding, by the device, a cache resource identifier in the device-initiated request packet, the cache resource identifier providing a steering hint for directing the data payload to a specific caching resource in a host system;
setting, by the device, a locality hint in the device-initiated request packet, the locality hint indicating one or more access characteristics of the data payload; and
directing, by the device, the data payload to the caching resource of the host system based on the cache resource identifier and the locality hint.

2. The method of claim 1, wherein the cache resource identifier is a multi-bit identifier indicating a specific caching resource.

3. The method of claim 1, wherein the cache resource identifier is used to direct the data payload to a specific core complex in the host system.

4. The method of claim 1, wherein the locality hint represents at least one of:
a priority of the data payload;
a non-temporal indicator;
a temporal indicator; or
a best-effort indicator for steering data placement.

5. The method of claim 1, further comprising programming the cache resource identifier by a device driver through topology-aware communication methods.

6. The method of claim 5, wherein the device driver programs the cache resource identifier based on host system topology information.

7. The method of claim 1, wherein the device-initiated request packet is a Device-to-Host (D2H) request packet.

8. The method of claim 1, further comprising updating the cache resource identifier dynamically based on changes in software scheduling.

9. A device comprising:
an interface configured to communicate over a cache-coherent memory protocol channel; and
at least one circuit configured to:
issue, via the interface, a write request over a cache-coherent memory protocol channel, the coherent write request comprising a data payload and a device-initiated request packet;
add a cache resource identifier in the device-initiated request packet, the cache resource identifier providing a steering hint for directing the data payload to a specific caching resource in a host system;
set a locality hint in the device-initiated request packet, the locality hint indicating one or more access characteristics of the data payload; and
direct, via the interface, the data payload to the caching resource of the host system based on the cache resource identifier and the locality hint.

10. The device of claim 9, wherein the cache resource identifier is a multi-bit identifier indicating a specific caching resource.

11. The device of claim 9, wherein the cache resource identifier is used to direct the data payload to a specific core complex in the host system.

12. The device of claim 9, wherein the locality hint represents at least one of:
an expected access pattern of the data payload;
a priority of the data payload;
a non-temporal indicator; or
a temporal indicator.

13. The device of claim 9, wherein the at least one circuit is further configured to program the cache resource identifier by a device driver through topology-aware communication methods.

14. The device of claim 13, wherein the device driver programs the cache resource identifier based on host system topology information.

15. The device of claim 9, wherein the device-initiated request packet is a Device-to-Host (D2H) request packet.

16. The device of claim 9, wherein the at least one circuit is further configured to update the cache resource identifier dynamically based on changes in software scheduling.

17. The device of claim 9, wherein the at least one circuit is further configured to direct the data payload to one of a plurality of different levels of cache.

18. A system comprising:
a host system communicatively coupled to a device via a cache-coherent memory protocol, the device comprising:
an interface configured to communicate over a cache-coherent memory protocol channel; and
at least one circuit configured to:
issue, via the interface, a write request over a cache-coherent memory protocol channel, the write request comprising a data payload and a device-initiated request packet;
add a cache resource identifier in the device-initiated request packet, the cache resource identifier providing a steering hint for directing the data payload to a specific caching resource in the host system;
set a locality hint in the device-initiated request packet, the locality hint indicating one or more access characteristics of the data payload; and
direct, via the interface, the data payload to the caching resource of the host system based on the cache resource identifier and the locality hint;
wherein the host system interprets the cache resource identifier and locality hint to optimize data placement within a caching resource.

19. The system of claim 18, further comprising a device driver that programs the cache resource identifier based on host system topology information.

20. The system of claim 18, wherein the at least one circuit is further configured to direct the data payload to one of a plurality of different levels of cache.
